(19) United States
(12) Patent Application Publication
(10) Pub. No.: US 2006/0134520 A1
(43) Pub. Date: Jun. 22, 2006

(54) Nonaqueous electrolyte battery, battery pack and positive electrode active material

(76) Inventors: Haruchika Ishii, Kawasaki-shi (JP); Shinsuke Matsuno, Kashiwa-shi (JP); Hidesato Saruwatari, Kawasaki-shi (JP); Hiroki Inagaki, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/298,601

(22) Filed: Dec. 12, 2005

(30) Foreign Application Priority Data
Dec. 20, 2004 (JP) 2004-367456

(51) Int. Cl. H01M 4/52; H01M 4/48; H01M 10/40

(52) U.S. Cl. 429/223; 429/231.1; 429/231.95; 429/337

(57) ABSTRACT

A nonaqueous electrolyte battery includes a case, a positive electrode housed in the case and including a positive electrode active material containing a lithium-nickel composite oxide and at least one of lithium hydroxide and lithium oxide, the sum of lithium hydroxide and lithium oxide falling within not less than 0.1% to not more than 0.5% by weight based on the total amount of the positive electrode active material, a negative electrode housed in the case and capable of lithium intercalation-deintercalation, and a separator sandwiched between the positive electrode and the negative electrode and impregnated with a nonaqueous electrolyte containing γ-butyrolactone.

### CROSS-REFERENCE TO RELATED APPLICATIONS

This application is based upon and claims the benefit of priority from prior Japanese Patent Application No. 2004-367456, filed Dec. 20, 2004, the entire contents of which are incorporated herein by reference.

### BACKGROUND OF THE INVENTION

1. Field of the Invention

The present invention relates to a nonaqueous electrolyte battery, a battery pack, and a positive electrode active material.

2. Description of the Related Art

The nonaqueous electrolyte battery attracts attentions as a battery having a high energy density. The nonaqueous electrolyte battery is charged and discharged by the migration of Li ions between the negative electrode and the positive electrode. The positive electrode active material used in the nonaqueous electrolyte battery includes, for example, a lithium-nickel composite oxide, and a lithium-cobalt composite oxide.

Particularly, the lithium-nickel composite oxide exhibits a large Li reversible charge-discharge capacity per unit weight. Therefore, the lithium-nickel composite oxide is studied vigorously as a hopeful positive electrode active material. For example, Jpn. Pat. Appln. KOKAI Publication No. 10-208728 discloses a nonaqueous electrolyte battery comprising a nonaqueous electrolyte prepared by dissolving an electrolyte in a mixed solvent consisting of ethylene carbonate and diethyl carbonate. In this publication, it is proposed to improve the initial capacity of the nonaqueous electrolyte battery by controlling, for example, the LiOH content in the lithium-nickel composite oxide.

However, the nonaqueous electrolyte battery using the lithium-nickel composite oxide is not satisfactory in the storage characteristics of the nonaqueous electrolyte battery under high temperatures.

### BRIEF SUMMARY OF THE INVENTION

An object of the present invention is to provide a nonaqueous electrolyte battery excellent in the storage characteristics under high temperatures, a battery pack comprising a plurality of such nonaqueous electrolyte batteries, and a positive electrode active material used in the particular nonaqueous electrolyte battery.

According to an aspect of the present invention, there is provided a nonaqueous electrolyte battery, comprising:

a case;

a positive electrode housed in the case and including a positive electrode active material containing a lithium-nickel composite oxide and at least one of lithium hydroxide and lithium oxide, the sum of lithium hydroxide and lithium oxide falling within not less than 0.1% to not more than 0.5% by weight based on the total amount of the positive electrode active material;

a negative electrode housed in the case and capable of lithium intercalation-deintercalation; and

a separator sandwiched between the positive electrode and the negative electrode and impregnated with a nonaqueous electrolyte containing γ-butyrolactone.

According to another aspect of the present invention, there is provided a battery pack comprising a plurality of nonaqueous electrolyte batteries, wherein the nonaqueous electrolyte battery comprises:

a case;

a positive electrode housed in the case and including a positive electrode active material containing a lithium-nickel composite oxide and at least one of lithium hydroxide and lithium oxide, the sum of lithium hydroxide and lithium oxide falling within not less than 0.1% to not more than 0.5% by weight based on the total amount of the positive electrode active material;

a negative electrode housed in the case and capable of lithium intercalation-deintercalation; and

a separator sandwiched between the positive electrode and the negative electrode and impregnated with a nonaqueous electrolyte containing γ-butyrolactone.

Furthermore, according to still another aspect of the present invention, there is provided a positive electrode active material, comprising a lithium-nickel composite oxide and at least one of lithium hydroxide and lithium oxide, wherein:

the sum of lithium hydroxide and lithium oxide falls within not less than 0.1% to not more than 0.5% by weight based on the total amount of the positive electrode active material;

the positive electrode active material has a core region and an outer region; and

the sum of lithium hydroxide and lithium oxide in the core region falls within not less than 50% to not more than 200% of the sum of lithium hydroxide and lithium oxide in the outer region.

### BRIEF DESCRIPTION OF THE SEVERAL VIEWS OF THE DRAWING

FIG. 1 is a cross sectional view schematically showing the construction of a flat type nonaqueous electrolyte secondary battery according to one embodiment of the present invention;

FIG. 2 is a cross sectional view schematically showing in detail in a magnified fashion the construction in the circular portion A shown in FIG. 1 of the nonaqueous electrolyte secondary battery;

FIG. 3 is an oblique view, partly broken away, schematically showing the construction of another flat type nonaqueous electrolyte secondary battery according to one embodiment of the present invention;

FIG. 4 is a cross sectional view showing in a magnified fashion the construction in the circular region B shown in FIG. 3 of the nonaqueous electrolyte secondary battery;

FIG. 5 is an oblique view showing in a dismantled fashion the construction of a battery pack according to another embodiment of the present invention; and

FIG. 6 is block diagram showing the electric circuit of the battery pack shown in FIG. 5.

### DETAILED DESCRIPTION OF THE INVENTION

It is found that the nonaqueous electrolyte battery containing a lithium-nickel composite oxide as the positive electrode active material is inferior to the nonaqueous electrolyte battery containing lithium-cobalt composite oxide as the positive electrode active material in the storage characteristics under high temperatures. As a result of an extensive research, the present inventors have found that a film formed on the surface of the positive electrode gives serious influences to the storage characteristics of the nonaqueous electrolyte battery under high temperatures.

To be more specific, in the initial charging stage, the lithium-cobalt composite oxide used as the positive electrode active material decomposes the nonaqueous electrolyte, with the result that a high quality film consisting of the decomposed materials is formed on the surface of the positive electrode. The film thus formed is dense and stable and has a low electric resistance and, thus, serves to suppress the decomposition of the nonaqueous electrolyte, though the nonaqueous electrolyte is decomposed vigorously under a high temperature environment. The gas generation accompanying the decomposition of the nonaqueous electrolyte is also suppressed by the film formed on the positive electrode. Such being the situation, the nonaqueous electrolyte battery comprising a lithium-cobalt composite oxide as the positive electrode active material exhibits satisfactory storage characteristics under high temperatures.

On the other hand, a high quality film as in the case of using the lithium-cobalt composite oxide is unlikely to be formed on the positive electrode in the case of using a lithium-nickel composite oxide as the positive electrode active material, resulting in failure to suppress the decomposition of the nonaqueous electrolyte. Such being the situation, the nonaqueous electrolyte battery comprising a lithium-nickel composite oxide as the positive electrode active material is rendered poor in the storage characteristics under high temperatures.

One embodiment of the present invention relates to a Li ion nonaqueous electrolyte battery. Another embodiment of the present invention relates a battery pack comprising a plurality of the nonaqueous electrolyte batteries. Furthermore, another embodiment of the present invention relates to a positive electrode active material used in the nonaqueous electrolyte battery.

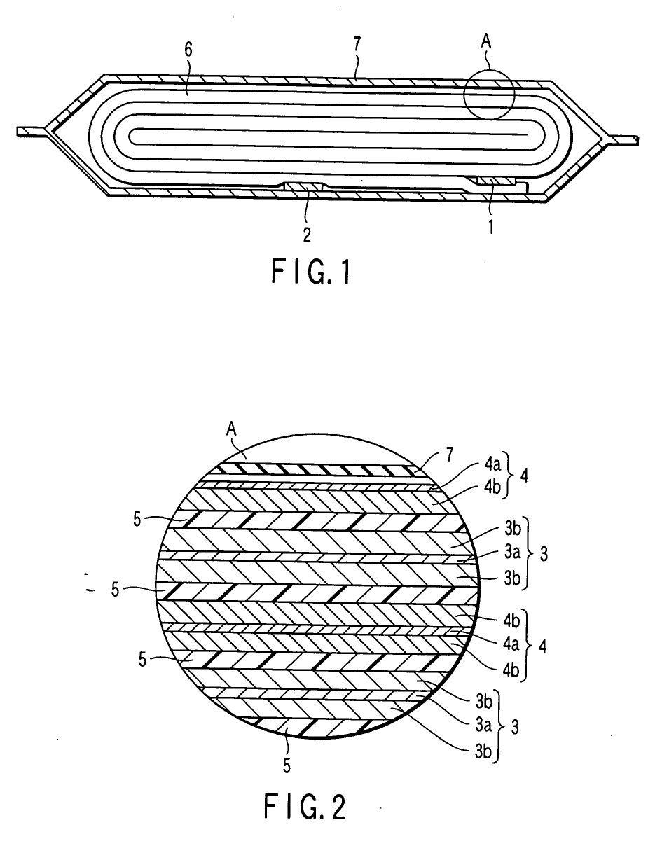

FIGS. 1 and 2 collectively show as an example the construction of the nonaqueous electrolyte battery according to one embodiment of the present invention. FIG. 1 is a cross sectional view schematically showing the construction of a flat type nonaqueous electrolyte secondary battery according to one embodiment of the present invention, and FIG. 2 is a cross sectional view schematically showing in detail the construction in the circular region A shown in FIG. 1 of the nonaqueous electrolyte secondary battery.

As shown in the drawings, a positive electrode terminal 1 is connected to a positive electrode 3, and a negative electrode terminal 2 is connected to a negative electrode 4. The positive electrode 3 and the negative electrode 4 are spirally wound with a separator 5 interposed between the positive electrode 3 and the negative electrode 4 so as to form a spirally wound electrode group 6 that is shaped flat. The wound electrode group 6 is housed in a case 7 filled with a nonaqueous electrolyte.

As shown in FIG. 1, the spirally wound electrode group 6 that is shaped flat is housed in the case 7 filled with a nonaqueous electrolyte. The negative electrode terminal 2 is connected to the outside in the vicinity of the outer circumferential edge of the wound electrode group 6. Also, the negative electrode terminal 2 is electrically connected to the negative electrode current collector of the negative electrode 4. On the other hand, the positive electrode terminal 1 is connected to the inside in the vicinity of the outer circumferential edge of the wound electrode group 6. Also, the positive electrode terminal 1 is electrically connected to the positive electrode current collector of the positive electrode 3. The wound electrode group 6 is formed of a laminate structure consisting of the negative electrode 4, the separator 5, the positive electrode 3 and the separator 5, which are laminated one upon the other in the order mentioned as viewed from the outermost layer. Also, the tip portions of the positive electrode terminal 1 and the negative electrode terminal 2 are withdrawn to the outside from the same side of the case 7.

The construction of the wound electrode group 6 will now be described more in detail. As shown in FIG. 2, the positive electrode 3 and the negative electrode 4 are arranged to face each other with the separator 5 interposed between the positive electrode 3 and the negative electrode 4 so as to form a laminate structure. The negative electrode 4 on the outermost side comprises a negative electrode current collector 4a and a negative electrode layer 4b, which are arranged to form a laminate structure in which the negative electrode current collector 4a is on the outside. Each of the other negative electrodes 4 comprises a negative electrode layer 4b, a negative electrode current collector 4a, and another negative electrode layer 4b, which are arranged to form a laminate structure. On the other hand, each of the positive electrodes 3 comprises a positive electrode layer 3b, a positive electrode current collector 3a and another positive electrode layer 3b, which are arranged to form a laminate structure.

The positive electrode, the nonaqueous electrolyte, the negative electrode, the separator and the case will now be described in detail.

1) Positive Electrode

The positive electrode comprises a positive electrode current collector and a positive electrode layer or positive electrode layers formed on one surface or on both surfaces of the positive electrode current collector. Also, the positive electrode layer contains a positive electrode active material, a positive electrode electronic conductor, and a binder.

The positive electrode active material comprises a lithium-nickel composite oxide and at least one of lithium hydroxide (LiOH) and lithium oxide (Li₂O). The sum of LiOH and Li₂O falls within not less than 0.1% to not more than 0.5% by weight based on the amount of the positive electrode active material.

The lithium-nickel composite oxide is represented by formula (1) given below. Specifically, the lithium-nickel composite oxide includes LiNiO₂, i.e., the oxide of formula (1), in which x is zero (x=0):
LiNi₁₋ₓMₓO² (1)

where the element M is at least one element selected from the group consisting of Co, Al, Mn, Cr, Fe, Nb, Mg, B and F, and the molar ratio x satisfies 0≦x<1.

It is desirable for the element M included in formula (1) to be selected from the group consisting of Co, Al and Mn because it has been confirmed in the Examples described herein later that these elements are effective for forming a high quality film on the surface of the positive electrode.

It is desirable for the molar ratio x in formula (1) to satisfy 0≦x≦0.5. If the molar ratio x satisfies 0≦x≦0.5, the influence of the Ni component is rendered predominant, therefore it is possible to exhibit the effect of the embodiment of the present invention prominently.

LiOH or Li₂O produces a catalytic effect for promoting the reaction to form a film described herein later. Therefore, even in the case of using a lithium-nickel composite oxide as the positive electrode active material, it is possible to form a dense and stable high quality film exhibiting a low electric resistance on the surface of the positive electrode. As a result, it is possible to suppress the decomposing reaction of the nonaqueous electrolyte, which is carried out prominently under a high temperature environment, so as to improve the storing characteristics of the nonaqueous electrolyte battery under high temperatures. It should be noted, however, that, if the sum of LiOH and Li₂O is smaller than 0.1% by weight of the positive electrode active material, it is impossible for LiOH and Li₂O to produce sufficiently the catalytic effect noted above. On the other hand, if the sum of LiOH and Li₂O exceeds 0.5% by weight of the positive electrode active material, the catalytic effect is produced excessively, resulting in failure to form a high quality film on the surface of the positive electrode. In this case, it is impossible to suppress the decomposition of the nonaqueous electrolyte. It is more desirable for the sum of LiOH and Li₂O to fall within not less than 0.1% to not more than 0.3% by weight based on the amount of the positive electrode active material. In this case, it is possible to prevent LiOH or Li₂O from mixing into the formed film. As a result, the formed film does not get thick excessively, therefore it is possible to prevent increase of the resistance of the film.

Where porous particles are used as the positive electrode active material, it is desirable for the concentration of the sum of LiOH and Li₂O in the core regions of the porous particles to be substantially equal to the concentration of the sum of LiOH and Li₂O in the outer regions of the porous particles. Incidentally, the particle is imaginarily divided in this case into the “outer region” and the “core region” noted above such that the boundary between the outer region and the core region from the surface of the particle is on 0.25 times as large as the particle diameter (μm) i.e., one-fourth of the particle diameter. In other words, the outer region is defined as the outer shell region of which thickness (μm) is smaller than 0.25 times as large as the particle diameter (μm). Likewise, the core region is defined as the spherical core region of which radius (μm) is not larger than 0.25 times as large as the particle diameter (μm), namely the boundary is defined as the core region. Where the particle is not spherical and has an elliptical cross section including the center of the particle, the thickness of the outer shell region is smaller than 0.25 times as large as the short diameter of the particle, and the radius of the spherical core region is not smaller than 0.25 times as large as the short diameter of the particle. Where the concentration of the sum of LiOH and Li₂O in the spherical core region falls within not less than 50% to not more than 200% of the concentration of the sum of LiOH and Li₂O in the outer shell region, the concentration of the sum of LiOH and Li₂O is substantially uniform over the entire particle including the outer shell region and the spherical core region. Particularly, where the concentration of the sum of LiOH and Li₂O in the spherical core region is not more than 200% of the concentration in the outer shell region, it is possible to suppress the elution of LiOH or Li₂O into the nonaqueous electrolyte. It follows that it is possible to prevent the side reaction of LiOH or Li₂O or to prevent the excessive formation of the surface film on the surface of the positive electrode. On the other hand, where the concentration of the sum of LiOH and Li₂O in the spherical core region is not less than 50% of the concentration in the outer shell region, it is possible to form the surface film on the surface of the positive electrode uniformly. It is possible for the positive electrode active material to be present in the form of secondary particles formed by agglomeration of the primary particles or in the form of the primary particles that are not agglomerated. Where the positive electrode active material is formed of the secondary particles, the distance (μm) of the boundary between the outer shell region and the spherical core region from the surface of the secondary particle, not the primary particle, is on 0.25 times as large as the diameter (μm) of the secondary particle.

Incidentally, LiOH and Li₂O have the relations of equilibrium determined by formula (2) given below. The amounts of LiOH and Li₂O are changed depending on the amount of water present in the atmosphere. Such being the situation, attentions are paid in the embodiment of the present invention to the total amount of LiOH and Li₂O:
Li₂O+H₂O=2 LiOH (2)

It is desirable for the amount of Li₂CO₃ to be not larger than 0.1% by weight of the positive electrode active material because Li₂CO₃ promotes the decomposing reaction of the nonaqueous electrolyte, said decomposing reaction being prominent under high temperatures, and also promotes the gas generation accompanying the decomposing reaction. It is more desirable for the amount of Li₂CO₃ to be not larger than 0.05% by weight of the positive electrode active material.

The positive electrode active material can be manufactured as exemplified in the following.

In the first step, LiOH or Li₂O is mixed with NiO by a dry mixing method using, for example, an automatic mortar. The amount of LiOH or Li₂O is made larger than a desired stoichiometric amount by not less than 1 mol % to mot more than 20 mol %. Also, it is desirable to carry out the mixing under a dry environment. To be more specific, it is desirable to carry out the mixing under a humidity not higher than 5%. Incidentally, where it is desirable to obtain a lithium-nickel composite oxide containing a substituting element M, a metal oxide of the element M is also mixed.

In the next step, the mixture thus obtained is burned at 400 to 800° C. for 4 to 48 hours under a high pressure oxygen atmosphere having the pressure controlled to 1.05 to 1.5 atms. Then, the mixture is pulverized and mixed under a dry environment by a dry mixing method using, for example, an automatic mortar.

The burning and the mixing by pulverization noted above are repeated a plurality of times. It is desirable for the burning and the mixing by pulverization to be repeated 2 to 10 times. If the number of repetitions is not smaller than 2, the concentration of LiOH or Li₂O is made uniform, with the result that the film is formed uniformly. On the other hand, if the number of repetitions is not larger than 10, it is possible to prevent the particle from being made excessively fine so as not to increase the specific surface area of the positive electrode active material. As a result, it is possible to suppress the decomposing reaction of the nonaqueous electrolyte so as to improve the storing characteristics of the nonaqueous electrolyte battery under high temperatures.

It is possible for the positive electrode active material thus manufactured to contain LiOH and Li₂O in an amount of 0.1 to 0.5% by weight of the positive electrode active material. It is also possible to decrease the amount of Li₂CO₃ contained in the positive electrode active material to 0.1% by weight or less of the positive electrode active material. It should also be noted that LiOH and Li₂O are allowed to be retained in the positive electrode active material. It follows that it is possible to suppress the decomposing reaction of the nonaqueous electrolyte, which is caused by the elusion of LiOH or Li₂O, and to suppress the gas generation accompanying the decomposing reaction of the nonaqueous electrolyte.

The positive electrode electronic conductor serves to enhance the current collecting performance and to suppress the contact resistance with the current collector. The positive electrode electronic conductor performing the particular function, which is used in the embodiment of the present invention, includes, for example, acetylene black, carbon black, graphite, Ni and Al. These positive electrode electronic conductors are granular or fibrous.

The binder contained in the positive electrode layer serves to permit the positive electrode active material and the positive electrode electronic conductor to be bonded to each other. The binder used for this purpose in the embodiment of the present invention includes, for example, polytetrafluoroethylene (PTFE) and polyvinylidene fluoride (PVdF). It is also possible to prepare the binder by mixing hexafluoropropylene, a silicone rubber, a butyl rubber, a chlorotrifluoroethylene rubber or an ethylene-propylene rubber with the polymer noted above.

When it comes to the mixing ratio of the positive electrode active material, the positive electrode electronic conductor, and the binder, it is desirable for the positive electrode active material to be mixed in an amount of not less than 80% to not more than 95% by weight, for the positive electrode electronic conductor to be mixed in an amount of not less than 3% to not more than 18% by weight, and for the binder to be mixed in an amount of not less than 2% to not more than 17% by weight. If the positive electrode electronic conductor is mixed in an amount not less than 3% by weight, it is possible to obtain the effect described above. Also, if the positive electrode electronic conductor is mixed in an amount not more than 18% by weight, it is possible to suppress the decomposition of the nonaqueous electrolyte on the surface of the positive electrode electronic conductor during storage of the nonaqueous electrolyte battery under high temperatures. Also, if the binder is mixed in an amount not less than 2% by weight, it is possible to obtain a sufficient electrode strength. Also, if the binder is mixed in an amount not more than 17% by weight, it is possible to decrease the mixing amount of the insulator in the electrode so as to decrease the internal resistance.

It is desirable for the positive electrode current collector to include an aluminum foil or an aluminum alloy foil containing an alloying element such as Mg, Zn, Mn, Fe or Si.

The positive electrode can be manufactured, for example, as follows.

In the first step, a slurry is prepared by suspending a positive electrode active material, a positive electrode electronic conductor and a binder in a suitable solvent. Then, a positive electrode current collector is coated with the slurry thus prepared, followed by drying the coated slurry so as to form a positive electrode layer and subsequently pressing the positive electrode current collector having the positive electrode layer formed thereon. Alternatively, it is also possible to mold a mixture containing a positive electrode active material, a positive electrode electronic conductor and a binder into pellets so as to form the positive electrode layer.

Incidentally, in the stage of suspending the positive electrode active material, the positive electrode electronic conductor and the binder in a solvent, it is desirable to disperse the binder in an organic solvent such as N-methylpyrrolidinone, followed by adding the additive given below into the solvent and subsequently dispersing the positive electrode active material and the positive electrode electronic conductor in the solvent. The additive noted above includes, for example, organic acids such as maleic acid, oxalic acid, malonic acid, formic acid, citric acid, acetic acid, lactic acid, pyruvic acid, propionic acid, citraconic acid, and butyric acid as well as anhydrides thereof. These additives serve to lower the viscosity of the slurry. These additives are used in an amount of not less than 10 ppm to not more than 10,000 ppm, preferably not less than 100 ppm to not more than 5,000 ppm, and more preferably not less than 500 ppm to not more than 2,500 ppm based on the positive electrode active material.

2) Nonaqueous Electrolyte

The nonaqueous electrolyte used in the embodiment of the present invention includes a liquid nonaqueous electrolyte and a gel nonaqueous electrolyte. The liquid nonaqueous electrolyte can be prepared by dissolving an electrolyte in a nonaqueous solvent. On the other hand, the gel nonaqueous electrolyte can be prepared by forming a composite material by mixing a liquid nonaqueous electrolyte with a polymer material.

The nonaqueous solvent of the nonaqueous electrolyte contains γ-butyrolactone.

γ-butyrolactone tends to bring about a ring opening polymerization reaction by the catalytic effect produced by LiOH or Li₂O, and the film formed on the surface of the positive electrode tends to contain the ring-opened polymer of γ-butyrolactone, which is formed by the ring opening polymerization noted above. If the sum of LiOH and Li₂O falls within the range described previously, the ring-opened polymer of γ-butyrolactone is formed appropriately so as to make it possible to form a high quality film, which is dense and stable and has a low resistivity, on the surface of the positive electrode.

The ring opening polymerization reaction of γ-butyrolactone is brought about by the scission of the ester bond CO—O or by the scission of O—C bond positioned adjacent to the ester bond. The ring-opened polymer has repeating units corresponding to the scission of the ester bond or the C—O bond adjacent to the ester bond. The edge portion of the ring-opened polymer is coupled or coordinated with a metal atom or an oxygen atom of the positive electrode active material. The ring-opened polymer of γ-butyrolactone can be detected by using, for example, XPS, reflection type FT-IR, solid NMR or liquid NMR.

In order to form a particularly satisfactory film on the surface of the positive electrode, it is desirable for γ-butyrolactone to be contained in an amount of not less than 10% to not more than 90% by volume of the nonaqueous solvent. It is more desirable for γ-butyrolactone to be contained in an amount of not less than 15% to not more than 60% by volume of the nonaqueous solvent.

It is desirable for the nonaqueous electrolyte to contain at least one of ethylene carbonate (EC) and propylene carbonate (PC).

It has been confirmed that, excluding γ-butyrolactone, ethylene carbonate or propylene carbonate is most effective for forming a high quality film on the surface of the positive electrode. It should be noted that the film containing the ring-opened polymer of ethylene carbonate or propylene carbonate has a high permittivity, permits smoothly Li intercalation and deintercalation, and contributes to the high output discharge characteristics of the nonaqueous electrolyte battery.

The ring opening polymerization reaction of ethylene carbonate or propylene carbonate is brought about by the scission of the ester bond CO—O or by the scission of the O—C bond positioned adjacent to the ester bond CO—O. The ring-opened polymer has repeating units corresponding to the scission of the ester bond CO—O or the scission of the O—C bond adjacent to the ester bond. The edge portion of the ring-opened polymer is coupled or coordinated with the metal atom or the oxygen atom of the positive electrode active material. The ring-opened polymer of ethylene carbonate or propylene carbonate can be detected like the detection of the ring-opened polymer of γ-butyrolactone.

It is desirable for ethylene carbonate or propylene carbonate to be contained in an amount of not less than 5% to not more than 60% by volume of the nonaqueous solvent. If the EC or PC is contained in an amount noted above, it is possible to form a particularly high quality film on the surface of the positive electrode. It is also possible to improve the solubility of the electrolyte. It is more desirable for EC or PC to be contained in an amount of not less than 10% to not more than 50% by volume of the nonaqueous solvent.

It is possible for the nonaqueous electrolyte to contain other nonaqueous solvent including, for example, a chain carbonate such as diethyl carbonate (DEC), dimethyl carbonate (DMC), or methyl ethyl carbonate (MEC), a chain ether such as dimethoxy ethane (DME) or diethoxy ethane (DEE), a cyclic ether such as tetrahydrofuran (THF), 2-methyl tetrahydrofuran (MTHF) or dioxolane (DOX), as well as acetonitrile (AN), sulfolane (SL), methyl propionate (PAM) and ethyl propionate (PAE).

The electrolyte used in the embodiment of the present invention includes, for example, LiBF₄, LiPF₆, LiCF₃SO₃, LiAsF₆, LiClO₄, LiN(CF₃SO₂)₂, LiN(C₂F₅SO₂)₂, Li(CF₃SO₂)₃C, and LiB[(OCO)₂]₂. Particularly, it is desirable to use LiBF₄ or LiPF₆ in view of, for example, the ion dissociation degree and the chemical stability. Also, it is desirable to use LiCF₃SO₃ as the electrolyte in view of the aspect of improving the storage characteristics of the nonaqueous electrolyte battery under high temperatures. The electrolytes exemplified above can be used singly or in the form of a mixture of a plurality of the compounds exemplified above.

The liquid nonaqueous electrolyte can be prepared by dissolving the electrolyte in an nonaqueous solvent such that, for example, the electrolyte is contained in the nonaqueous electrolyte in a concentration of not less than 0.5 mol/L to not more than 2 mol/L.

The polymer material used for preparing the gel nonaqueous electrolyte includes, for example, polyvinylidene fluoride (PVdF), polyacrylonitrile (PAN) and polyethylene oxide (PEO).

3) Negative Electrode

The negative electrode comprises a negative electrode current collector and a negative electrode layer formed on one surface of the negative electrode current collector or negative electrode layers formed on both surfaces of the negative electrode current collector. The negative electrode layer contains a negative electrode active material, a negative electrode electronic conductor and a binder.

The negative electrode active material used in the embodiment of the present invention includes, for example, a carbonaceous material, a metal oxide, a metal sulfide, a metal nitride and a metal alloy, which permit lithium ions intercalation and deintercalation.

The carbonaceous material used in the embodiment of the present invention as the negative electrode active material includes, for example, coke, a carbon fiber, a thermally decomposed vapor-grown carbon material, graphite, a burning material of resin, and a burning material of a mesophase pitch based carbon fiber or mesophase spherical carbon. Particularly, it is desirable to use as the negative electrode active material a mesophase pitch based carbon fiber or a mesophase spherical carbon that has been graphitized by the heat treatment under temperatures not lower than 2,500° C. because the negative electrode active material exemplified above permits increasing the electrode capacity.

The metal oxide used in the embodiment of the present invention as the negative electrode active material includes, for example, lithium titanate (Li₄₊ₓTi₅O₁₂), tungsten oxide (WO₃), an amorphous tin oxide (e.g., SnB_{0.4}P_{0.6}O_{3.1}), tin-silicon oxide (SnSiO₃), and silicon oxide (SiO). Particularly, it is desirable to use lithium titanate (Li₄₊ₓTi₅O₁₂) as the negative electrode active material because lithium dendrite is unlikely to be generated even in the case of rapidly charging-discharging the nonaqueous electrolyte battery. Incidentally, an experiment similar to that conducted in the Example described herein later has been applied to the spinel type lithium titanate, as a result of which substantially the same result as the Example could be obtained.

The metal sulfide used in the embodiment of the present invention as the negative electrode active material includes, for example, iron sulfides (FeS, FeS₂, LiₓFeS₂), lithium sulfide (LiS₂) and molybdenum sulfide (MoS₂).

Also, the metal nitride used in the embodiment of the present invention as the negative electrode active material includes, for example, lithium-cobalt nitride (LiₓCo_{y}N, 0<x<4, 0<y<0.5).

Further, the metal alloy used in the embodiment of the present invention as the negative electrode active material includes, for example, aluminum, an aluminum alloy, a magnesium alloy, a lithium metal and a lithium alloy.

The carbon material can be used as the electronic conductor of the negative electrode. The carbon material noted above includes, for example, acetylene black, carbon black, coke, a carbon fiber and graphite.

The binder contained in the negative electrode layer includes, for example, polytetrafluoroethylene (PTFE), polyvinylidene fluoride (PVdF), an ethylene-propylene-diene terpolymer (EPDM), a styrene-butadiene rubber (SBR) and carboxymethyl cellulose (CMC).

Where the negative electrode potential of the negative electrode active material is baser than 1.0 V (vs. Li) when the negative electrode is charged full, the negative electrode current collector includes, for example, a copper foil and a nickel foil. It is desirable to use a copper foil as the negative electrode current collector in view of the electrochemical stability and the flexibility in the winding stage during the preparation of the electrode group. In the case of using a copper foil as the negative electrode current collector, it is desirable for the negative electrode current collector to have a thickness falling within not smaller than 8 μm to not larger than 40 μm.

Where the negative electrode potential of the negative electrode active material is nobler than 1.0 V (vs. Li) when the negative electrode is charged full, it is desirable in view of the electrochemical stability that the negative electrode current collector includes an aluminum foil or an aluminum alloy foil containing an alloying element selected from the group consisting of Mg, Ti, Zn, Mn, Fe, Cu, and Si. In the case of using an aluminum foil or an aluminum alloy foil, it is desirable for the negative electrode current collector to have a thickness falling within not smaller than 8 μm to not larger than 25 μm.

When it comes to the mixing ratio of the negative electrode active material, electronic conductor and the binder in the negative electrode layer, it is desirable for the negative electrode active material to be contained in an amount of not less than 80% to not more than 95% by weight, for the electronic conductor to be contained in an amount of not less than 3% to not more than 20% by weight, and for the binder to be contained in an amount of not less than 2% to not more than 7% by weight. Where the electronic conductor is contained in an amount not more than 20% by weight, it is possible to suppress the decomposition of the nonaqueous electrolyte on the surface of the electronic conductor during storage of the nonaqueous electrolyte battery under high temperatures. Also, where the binder is contained in an amount not less than 2% by weight, it is possible to obtain a sufficient electrode strength. Also, if the binder is contained in an amount not more than 7% by weight, it is possible to decrease the ratio of the insulator in the electrode.

The negative electrode can be manufactured, for example, as follows.

In the first step, a slurry is prepared by suspending a negative electrode active material, a negative electrode electronic conductor and a binder in a general purpose solvent. Then, the negative electrode current collector is coated with the slurry thus prepared, followed by drying the coated slurry so as to form a negative electrode layer and subsequently pressing the negative electrode current collector having the negative electrode layer formed thereon. Alternatively, it is also possible mold a mixture containing a negative electrode active material, a negative electrode electronic conductor and a binder into pellets so as to form a negative electrode layer.

The solvent used in the embodiment of the present invention for dispersing the negative electrode active material, the negative electrode electronic conductor and the binder includes, for example, N-methyl-2-pyrrolidone (NMP), and dimethyl formamide (DMF).

4) Separator

The separator used in the embodiment of the present invention includes, for example, a porous film containing polyethylene, polypropylene, cellulose or polyvinylidene fluoride (PVdF), and an unwoven fabric made of synthetic resin. Particularly, in view of the safety, it is desirable to use a porous film made of polyethylene or polypropylene as the separator because the porous film made of polyethylene or polypropylene can be melted under a given temperature so as to cut off the electric current.

5) Case

The case used in the embodiment of the present invention includes, for example, a laminate film having a thickness not larger than 0.2 mm and a metal sheet having a thickness not larger than 0.5 mm. It is more desirable for the metal sheet to have a thickness not larger than 0.2 mm.

The laminate film noted above denotes a multi-layered film comprising a metal layer and a resin layer covering the metal layer. For decreasing the weight, it is desirable for the metal layer included in the laminate film to be formed of an aluminum foil or an aluminum alloy foil. On the other hand, the resin layer covering the metal layer can be formed of a polymer such as polypropylene (PP), polyethylene (PE), Nylon, or polyethylene terephthalate (PET). The laminate film can be formed into the case by sealing the peripheral regions of the laminate film by employing the heat seal.

The metal sheet used for preparing the case includes, for example, aluminum and an aluminum alloy. It is desirable for the aluminum alloy used for forming the case to contain an alloying element selected from the group consisting of magnesium, zinc and silicon. On the other hand, it is desirable for the amount of the transition metal such as iron, copper, nickel or chromium, which are contained in the aluminum alloy, to be not larger than 100 ppm.

It is possible for the nonaqueous electrolyte secondary battery of the embodiment of the present invention to be of a laminate type, a prismatic type, a coin type, or a button type. Of course, it is possible for the nonaqueous electrolyte secondary battery of the embodiment of the present invention to be a large battery that is mounted to a vehicle having two to four wheels in addition to a small battery that is mounted to, for example, a portable electronic apparatus. Incidentally, the high temperature characteristics such as the storing characteristics under high temperature are particularly required in the nonaqueous electrolyte battery mounted to a vehicle. It follows that the nonaqueous electrolyte battery according to this embodiment of the present invention particularly exhibits the effects of the present invention when the nonaqueous electrolyte battery is mounted to a vehicle.

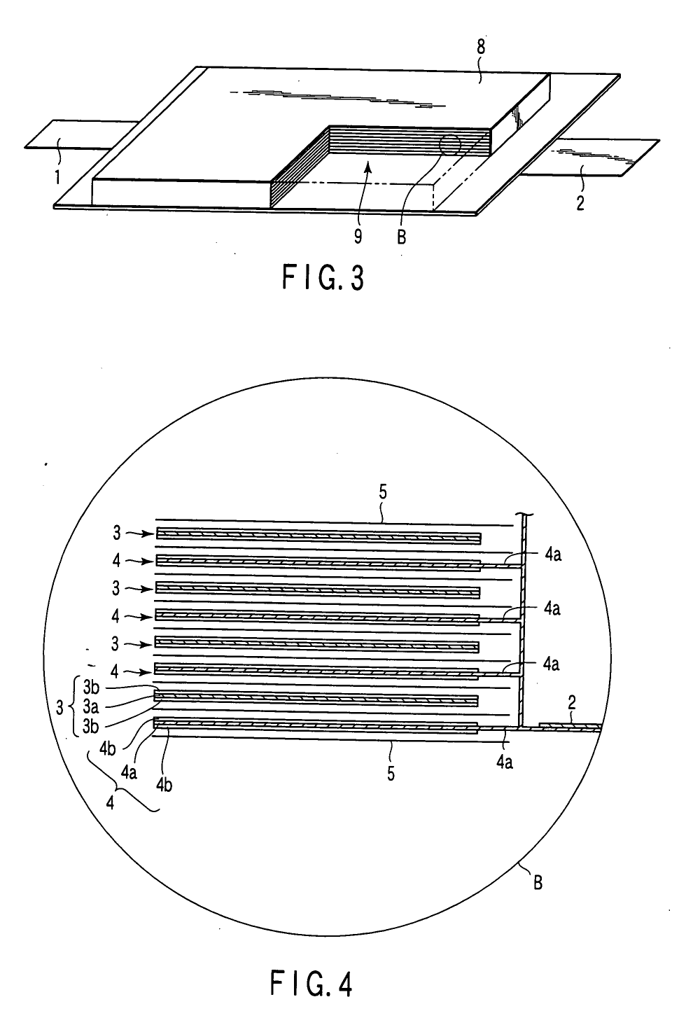

The construction of the nonaqueous electrolyte battery according to this embodiment of the present invention is not limited to that shown in FIGS. 1 and 2. For example, it is possible for the nonaqueous electrolyte battery of the present invention to be constructed as shown in FIGS. 3 and 4. FIG. 3 is an oblique view, partly broken away, schematically showing the construction of another flat type nonaqueous electrolyte secondary battery according to the embodiment of the present invention, and FIG. 4 is a cross sectional view showing in a magnified fashion the construction in the circular portion B shown in FIG. 3 of the nonaqueous electrolyte secondary battery.

As shown in FIG. 3, a laminate type electrode group 9 is housed in a case 8 formed of a laminate film. As shown in FIG. 4, the laminate type electrode group 9 comprises a positive electrode 3 and a negative electrode 4, which are laminated one upon the other with a separator 5 interposed between the positive electrode 3 and the negative electrode 4. Each of a plurality of positive electrodes 3 includes a positive electrode current collector 3a and positive electrode layers 3b formed on both surfaces of the positive electrode current collector 3a. Likewise, each of a plurality of negative electrodes 4 includes a negative electrode current collector 4a and negative electrode layers 4b formed on both surfaces of the negative electrode current collector 4a. One side of the negative electrode current collector 4a included in each negative electrode 4 protrudes from the positive electrode 3. The negative electrode current collector 4a protruding from the positive electrode 3 is electrically connected to a band-like negative electrode terminal 2. The distal end portion of the band-like negative electrode terminal 2 is withdrawn from the case 8 to the outside. Also, one side of the positive electrode current collector 3a included in the positive electrode 3 is positioned on the side opposite to the protruding side of the negative electrode current collector 4a and is protruded from the negative electrode 4, though the particular construction is not shown in the drawing. The positive electrode current collector 3a protruding from the negative electrode 4 is electrically connected to a band-like positive electrode terminal 1. The distal end portion of the band-like positive electrode terminal 1 is positioned on the side opposite to the side of the negative electrode terminal 2 and is withdrawn from the side of the case 8 to the outside.

A battery pack according to a second embodiment of the present invention comprises a plurality of unit cells formed of the nonaqueous electrolyte batteries according to the first embodiment of the present invention described above. The unit cells are electrically connected to each other in series or in parallel so as to form a battery module.

The unit cell, or nonaqueous electrolyte battery, according to the embodiment of the present invention is adapted for preparation of the battery module, and the battery pack according to the second embodiment of the present invention is excellent in the storing characteristics under high temperatures. It is possible to use the flat type secondary battery constructed as shown in FIG. 1 or FIG. 3 as the unit cell.

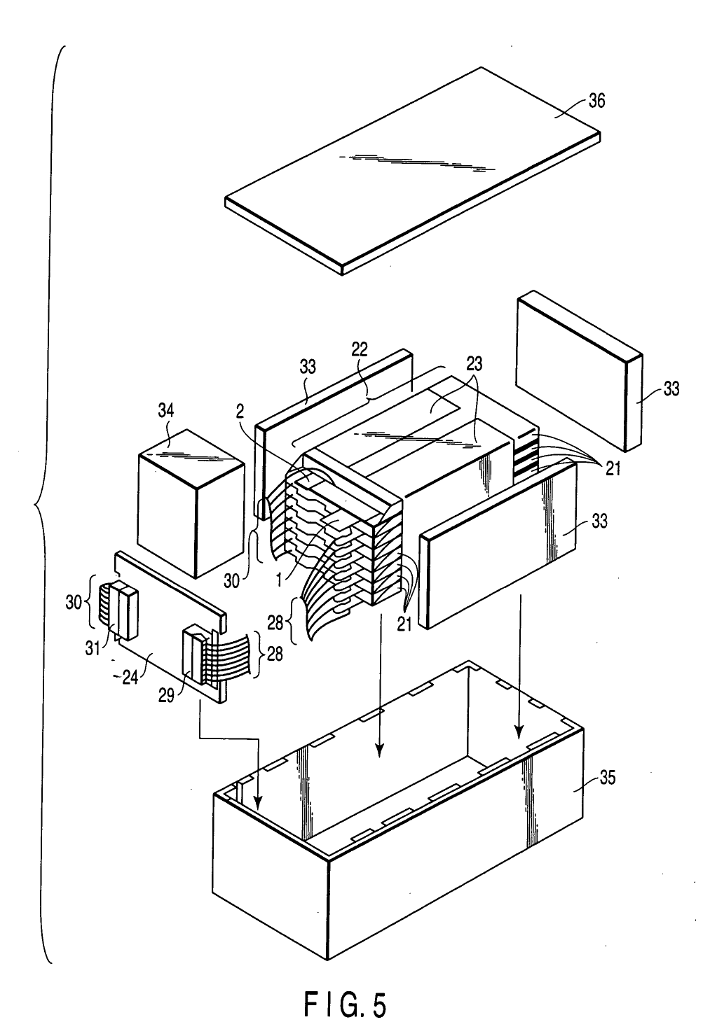

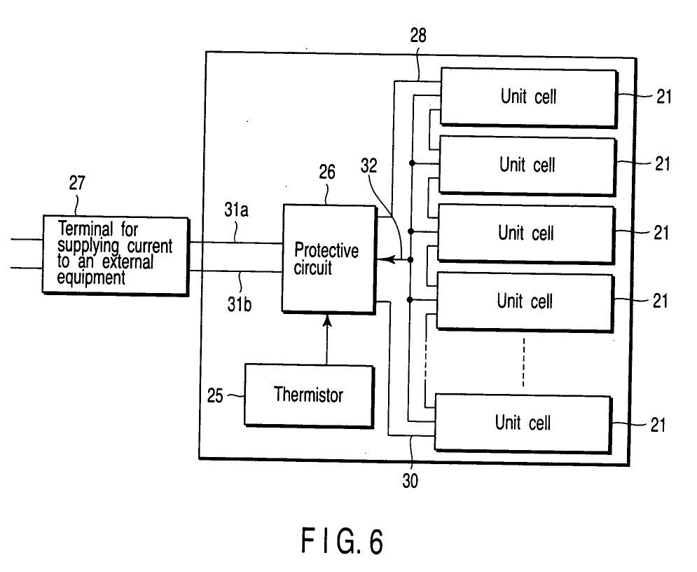

A unit cell 21 included in the battery pack shown in FIG. 5 is formed of the flat type nonaqueous electrolyte battery constructed as shown in FIG. 1. A plurality of unit cells 21 are stacked one upon the other in the thickness direction in a manner to align the extruding direction of each of the positive electrode terminals 1 and the negative electrode terminals 2. As shown in FIG. 6, the unit cells 21 are connected to each other in series so as to form a battery module 22. The unit cells 21 forming the battery module 22 are arranged integral by an adhesive tape 23, as shown in FIG. 5.

A printed wiring board 24 is arranged on the side region toward which protrude the positive electrode terminals 1 and the negative electrode terminals 2. As shown in FIG. 6, a thermistor 25, a protective circuit 26 and a terminal 27 for the power supply to the external equipment are mounted to the printed wiring board 24.

As shown in FIGS. 5 and 6, a wiring 28 on the side of the positive electrode of the battery module 22 is electrically connected to a connector 29 on the side of the positive electrode of the protective circuit 26 mounted to the printed wiring board 24. On the other hand, a wiring 30 on the side of the negative electrodes of the battery module 22 is electrically connected to a connector 31 on the side of the negative electrode of the protective circuit 26 mounted to the printed wiring board 24.

The thermistor 25 detects the temperature of the unit cell 21, and transmits the detection signal to the protective circuit 26. The protective circuit 26 is capable of breaking a wiring 31a on the positive side and a wiring 31b on the negative side, the wirings 31a and 31b being stretched between the protective circuit 26 and the terminal 27 for current supply to the external equipment. These wirings 31a and 31b are broken by the protective circuit 26 under prescribed conditions including, for example, the conditions that the temperature detected by the thermistor 25 is higher than a prescribed temperature, and that the over-charging, the over-discharging and the over-current of the unit cell 21 have been detected. The detecting method is applied to the unit cells 21 or to the battery module 22. In the case of applying the detecting method to each of the unit cells 21, it is possible to detect the battery voltage, the positive electrode potential or the negative electrode potential. On the other hand, where the positive electrode potential or the negative electrode potential is detected, lithium electrodes used as reference electrodes are inserted into the unit cells 21.

In the case of FIG. 6, a wiring 32 is connected to each of the unit cells 21 for detecting the voltage, and the detection signal is transmitted through these wirings 32 to the protective circuit 26.

Further, in the case shown in FIG. 6, all the unit cells 21 included in the battery module 22 are detected in terms of voltage. Although it is particularly desirable for the voltages of all of the unit cells 21 of the battery module 22 to be detected, it may be sufficient to check the voltages of only some of the unit cells 21.

Protective sheets 33 each formed of rubber or resin are arranged on the three of the four sides of the battery module 22, though the protective sheet 33 is not arranged on the side toward which protrude the positive electrode terminals 1 and the negative electrode terminals 2. A protective block 34 formed of rubber or resin is arranged in the clearance between the side surface of the battery module 22 and the printed wiring board 24.

The battery module 22 is housed in a container 35 together with each of the protective sheets 33, the protective block 34 and the printed wiring board 24. To be more specific, the protective sheets 33 are arranged inside the two long sides of the container 35 and inside one short side of the container 35. On the other hand, the printed wiring board 24 is arranged along that short side of the container 35 which is opposite to the short side along which one of the protective sheets 33 is arranged. The battery module 22 is positioned within the space surrounded by the three protective sheets 33 and the printed wiring board 24. Further, a lid 36 is mounted to close the upper open edge of the container 35.

Incidentally, it is possible to use a thermally shrinkable tube in place of the adhesive tape 23 for fixing the battery module 22. In this case, the protective sheets 33 are arranged on both sides of the battery module 22 and, after the thermally shrinkable tube is wound about the protective sheets, the tube is thermally shrunk so as to fix the battery module 22.

The unit cells 21 shown in FIGS. 5 and 6 are connected in series. However, it is also possible to connect the unit cells 21 in parallel so as to increase the cell capacity. Of course, it is possible to connect the battery packs in series and in parallel.

Also, the construction of the battery pack can be changed appropriately depending on the use of the battery pack.

It is desirable for the battery pack to be used under a high temperature environment. To be more specific, the battery pack can be mounted to, for example, a power supply for a digital camera, to vehicles such as a hybrid electric automobile having two to four wheels, an electric automobile having two to four wheels, and an assistant bicycle. Since the nonaqueous electrolyte battery for vehicles is particularly required to exhibit good high temperature characteristics such as storing characteristics under high temperatures, the nonaqueous electrolyte battery according to the embodiment of the present invention exhibits the particularly prominent effects thereof when mounted to vehicles.

Described in the following are Examples of the present invention. Needless to say, the technical scope of the present invention is not limited by the following Examples as far as the subject matter of the present invention is not exceeded.

The manufacturing method of the nonaqueous electrolyte battery according to Examples of the present invention and Comparative Examples will now be described.

### EXAMPLE 1

A lithium-nickel composite oxide was manufactured by the manufacturing method described above. In the first mixing stage, LiOH was mixed with a metal oxide corresponding to a desired lithium-nickel composite oxide. Also, the burning and the mixing by pulverization were repeated twice. Then, the sum of LiOH and Li₂O contained in the lithium-nickel composite oxide was measured by the pH titration. In this case, the lithium-nickel composite oxide was dispersed in water, and the pH titration was performed to this solution.

Also, the concentration of the sum of LiOH and Li₂O in the spherical core region of the positive electrode active material was measured as follows in respect of the lithium-nickel composite oxide.

Specifically, the positive electrode active material was pulverized for 2 hours in a planetary ball mill, and the pulverized material was observed with the particle size distribution analyzer. As a result, the average particle diameter of the pulverized positive electrode active material was found to be half the average particle diameter of the positive electrode active material before the pulverization. The pH value of the pulverized material was measured as above. The concentration of the sum of LiOH and Li₂O was found to be 0.3% by weight. The difference in concentration of the sum of LiOH and Li₂O between the positive electrode active material before the pulverization and the positive electrode active material after the pulverization indicates that the concentration of the sum of LiOH and Li₂O in the spherical core region was 0.2%. It was confirmed from the result of these measurements that the concentration of the sum of LiOH and Li₂O in the spherical core region of the positive electrode active material was 200% of the concentration of the sum of LiOH and Li₂O in the outer shell region of the positive electrode active material.

A lithium-nickel composite oxide having the composition shown in Table 1 and having the concentration of the sum of LiOH and Li₂O shown in Table 1 was used as the positive electrode active material. The lithium-nickel composite oxide noted above, acetylene black used as a positive electrode electronic conductor and polyvinylidene fluoride used as a binder were mixed in a mixing ratio by weight of 100:5:3 and, then, the mixture was dispersed in N-methylpyrrolidinone (NMP) so as to prepare a slurry. One surface of an aluminum foil having a thickness of 20 μm was coated with the slurry thus prepared, followed by drying the coated slurry and, then, pressing the aluminum foil coated with the slurry so as to obtain an aluminum foil having a positive electrode layer having an bulk density of 3 g/cm³. Further, a positive electrode was prepared by punching the aluminum foil having the positive electrode layer in a size of 2 cm×2 cm.

On the other hand, a mesophase spherical carbon used as a negative electrode active material, acetylene black used as a negative electrode electronic conductor and polyvinylidene fluoride used as a binder were mixed in a weight ratio of 100:10:10, followed by dispersing the resultant mixture in N-methyl pyrrolidinone so as to prepare a slurry. One surface of a copper foil having a thickness of 15 μm was coated with the slurry, followed by drying the coated slurry and, then, pressing the copper foil coated with the slurry so as to obtain a copper foil having a negative electrode layer having an bulk density of 1.3 g/cm³. Further, a positive electrode was prepared by punching the copper foil having the negative electrode layer in a size of 2 cm×2 cm.

Further, a nonaqueous electrolyte was prepared by dissolving an electrolyte in a mixture of nonaqueous solvents that were mixed in a volume ratio shown in Table 1. The electrolyte was dissolved in the mixed solvent in a concentration shown in Table 1.

The positive electrode and the negative electrode were housed in a glass container used as a case. In this case, the positive electrode and the negative electrode were arranged to face each other with a separator formed of a glass filter sandwiched therebetween. The positive electrode and the negative electrode were dipped completely in the nonaqueous electrolyte so as to manufacture a nonaqueous electrolyte battery for Example 1.

### EXAMPLES 2 TO 10 AND COMPARATIVE EXAMPLES 1 to 4

A lithium-nickel composite oxide was manufactured as in Example 1, except that the burning conditions and the number of repetitions of the burning and the mixing by the pulverization were changed. Then, a nonaqueous electrolyte battery was manufactured as in Example 1, except that the lithium-nickel composite oxide thus manufactured was used as the positive electrode active material.

A charge-discharge test was applied once to each of the nonaqueous electrolyte batteries thus manufactured under an environment of 20° C. so as to measure the discharge capacity of the nonaqueous electrolyte battery. Then, the nonaqueous electrolyte battery was charged again and the charged nonaqueous electrolyte battery was left to stand within a thermostat chamber of 80° C. for 3 days. After put again under an environment of 20° C., the nonaqueous electrolyte battery was discharged, followed by applying once a charge-discharge test to the nonaqueous electrolyte battery so as to measure the discharge capacity. Incidentally, the charge-discharge test was conducted under a constant current-constant voltage of 1 mA/cm², the nonaqueous electrolyte battery was charged to reach a battery voltage of 4.3 V, and the nonaqueous electrolyte battery was discharged to reach the battery voltage of 3 V.

Table 1 also shows the capacity retention ratio, which was calculated by comparing the discharge capacities of the nonaqueous electrolyte battery measured before and after the nonaqueous electrolyte battery was left to stand under the thermostat chamber.

The film formed on the surface of the positive electrode was detected as follows in respect of the battery for Example 1.

Specifically, the positive electrode was taken out of the nonaqueous electrolyte after the charging and discharging, and the positive electrode layer was peeled from the current collector formed of the aluminum foil and kept dipped for 24 hours in a deuterium solvent of γ-butyrolactone. A liquid NMR measurement was applied to the solution. In this case, ¹H (proton) and ¹³C (carbon 13) were used as nuclide. It was confirmed from the chemical shift value of the carbonyl oxygen that the ring-opened polymer of γ-butyrolactone was contained in the film formed on the positive electrode. Likewise, it was also confirmed that the ring-opened polymer of γ-butyrolactone was contained in film formed on the positive electrode in respect of the nonaqueous electrolyte battery obtained in each of Examples 2 to 10. When it comes to the nonaqueous electrolyte battery obtained in each of Examples 1 to 5 and 8 to 11, it was confirmed that the ring-opened polymer of ethylene carbonate or propylene carbonate was contained in the film formed on the surface of the positive electrode.

TABLE 1

| | Positive electrode active material | | Nonaqueous solvent | | | | Capacity |
|---|---|---|---|---|---|---|---|
| | Lithium-nickel | LiOH + Li₂O | [volume ratio] | Electrolyte [mol/L] | | | retention |
| | composite oxide | [wt %] | GBL/EC/PC/DMC/DEC/MEC | LiBF₄ | LiPF₆ | LiCF₃SO₃ | ratio [%] |
| Example 1 | LiNi_{0.7}Co_{0.2}Al_{0.1}O₂ | 0.1 | 2/1/0/0/0/0 | 1.5 | — | — | 99 |
| Example 2 | LiNi_{0.7}Co_{0.2}Al_{0.1}O₂ | 0.3 | 2/1/0/0/0/0 | 1.5 | — | — | 99 |
| Example 3 | LiNi_{0.7}Co_{0.2}Al_{0.1}O₂ | 0.5 | 2/1/0/0/0/0 | 1.5 | — | — | 99 |
| Example 4 | LiNi_{0.7}Co_{0.2}Al_{0.1}O₂ | 0.3 | 2/0/1/0/0/0 | 1.5 | — | — | 99 |
| Example 5 | LiNi_{0.7}Co_{0.2}Al_{0.1}O₂ | 0.3 | 1/4/5/0/0/0 | 1.5 | — | — | 99 |
| Example 6 | LiNi_{0.7}Co_{0.2}Al_{0.1}O₂ | 0.3 | 1/0/0/4/5/0 | 1.5 | — | — | 95 |
| Example 7 | LiNi_{0.7}Co_{0.2}Al_{0.1}O₂ | 0.3 | 1/0/0/4/5/0 | — | — | 1.5 | 97 |
| Example 8 | LiNiO₂ | 0.1 | 2/1/0/0/0/0 | 1.5 | — | — | 97 |
| Example 9 | LiNi_{0.8}Co_{0.2}O₂ | 0.3 | 1/1/1/0/0/0 | — | 2.5 | — | 98 |
| Example 10 | LiNi_{0.5}Co_{0.3}Mn_{0.2}O₂ | 0.3 | 1/1/0/0/0/0 | 1.5 | — | — | 97 |
| Comparative | LiNi_{0.7}Co_{0.2}Al_{0.1}O₂ | 0 | 2/1/0/0/0/0 | 1.5 | — | — | 45 |
| Example 1 | | | | | | | |
| Comparative | LiNi_{0.7}Co_{0.2}Al_{0.1}O₂ | 0.7 | 2/1/0/0/0/0 | 1.5 | — | — | 60 |
| Example 2 | | | | | | | |
| Comparative | LiNi_{0.7}Co_{0.2}Al_{0.1}O₂ | 0.3 | 0/1/0/0/0/2 | 1.5 | — | — | 45 |
| Example 3 | | | | | | | |
| Comparative | LiNiO₂ | 0.3 | 0/1/0/0/1/0 | 1.0 | — | — | 40 |
| Example 4 | | | | | | | |

Incidentally, the abbreviations of nonaqueous solvents shown in Table 1 are as follows:

GBL: γ-butyrolactone;

EC: ethylene carbonate;

PC: propylene carbonate;

DMC: dimethyl carbonate;

DEC: diethyl carbonate;

MEC: methyl ethyl carbonate;

As shown in Table 1, the capacity retention ratio of the nonaqueous electrolyte battery for each of Examples 1 to 10 was found to be higher than that of the nonaqueous electrolyte battery for each of Comparative Examples 1 to 4, supporting that the nonaqueous electrolyte battery according to the embodiment of the present invention is excellent in the storing characteristics under high temperatures.

Particularly, the capacity retention ratio of the nonaqueous electrolyte battery for each of Examples 1 to 3 was found to be higher than that of the nonaqueous electrolyte battery for each of Comparative Examples 1 and 2. The experimental data clearly support that, where the sum of LiOH and Li₂O contained in the positive electrode active material falls within not less than 0.1% to not more than 0.5% by weight, the nonaqueous electrolyte battery exhibits excellent storing characteristics under high temperatures.

Also, the capacity retention ratio of the nonaqueous electrolyte battery for Example 2 was found to be higher than that of the nonaqueous electrolyte battery for Comparative Example 3. The experimental data clearly support that the nonaqueous electrolyte battery using a nonaqueous electrolyte containing γ-butyrolactone exhibits excellent storing characteristics under high temperatures.

Further, the capacity retention ratio of the nonaqueous electrolyte battery for Example 5 was found to be higher than that of the nonaqueous electrolyte battery for Example 6. The experimental data clearly support that the nonaqueous electrolyte battery using a nonaqueous electrolyte containing at least one of ethylene carbonate and propylene carbonate exhibits further improved storing characteristics under high temperatures.

Also, the nonaqueous electrolyte battery for each of Examples 8 to 10 exhibits a high capacity retention ratio. This clearly indicates that a nonaqueous electrolyte battery exhibits particularly excellent storing characteristics under high temperatures in the case where the molar ratio x included in formula (1) given previously, which represents the lithium-nickel composite oxide used as the positive electrode active material, satisfies 0≦x≦0.5. In the Examples of the present invention, the element M of the lithium-nickel composite oxide, which is included in formula (1), denotes Co, Al or Mn. Therefore, these Examples clearly indicate that a nonaqueous electrolyte battery exhibits satisfactory storing characteristics under high temperatures in the case where the element M in formula (1) is at least one element selected from the group consisting of Co, Al and Mn.

Still further, the capacity retention ratio of the nonaqueous electrolyte battery for Example 7 was found to be higher than that of the nonaqueous electrolyte battery for Example 6. The experimental data clearly support that the nonaqueous electrolyte battery containing LiCF₃SO₃ as the electrolyte exhibits further improved storing characteristics under high temperatures.

Incidentally, the capacity retention ratio of the nonaqueous electrolyte battery for Comparative Example 4 was found to be lower than that of the nonaqueous electrolyte battery for each of Examples 1 to 10. The capacity retention ratio of the nonaqueous electrolyte battery for Comparative Example 4 was low because the nonaqueous electrolyte for this Comparative Example did not contain γ-butyrolactone. It is considered reasonable to understand that, since γ-butyrolactone was not contained in the nonaqueous electrolyte in Comparative Example 4, it was impossible to form a film sufficiently on the surface of the positive electrode. As a result, it was impossible to suppress the decomposition of the nonaqueous electrolyte, leading to the low capacity retention ratio noted above.

Incidentally, a lithium-nickel composite oxide was manufactured as in Example 1, except that the burning conditions and the number of repetitions of the burning and the mixing by pulverization were changed. The concentration of the sum of LiOH and Li₂O was measured as in Example 1 in respect of the lithium-nickel composite oxide. The concentration of the sum of LiOH and Li₂O thus measured was found to be 0.2% by weight for the outer shell region and 0.1% by weight for the spherical core region of the composite oxide. In other words, the concentration of the sum of LiOH and Li₂O in the spherical core region of the positive electrode active material was found to be 50% of the concentration of the sum of LiOH and Li₂O in the outer shell region. A nonaqueous electrolyte battery was manufactured as in Example 1, except that particular the lithium-nickel composite oxide was used as the positive electrode active material contained in the positive electrode layer. The capacity retention ratio of the nonaqueous electrolyte battery was found to be substantially equal to that for Example 1.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A nonaqueous electrolyte battery, comprising:
a case;
a positive electrode housed in the case and including a positive electrode active material containing a lithium-nickel composite oxide and at least one of lithium hydroxide and lithium oxide, the sum of lithium hydroxide and lithium oxide falling within not less than 0.1% to not more than 0.5% by weight based on the total amount of the positive electrode active material;
a negative electrode housed in the case and capable of lithium intercalation-deintercalation; and
a separator sandwiched between the positive electrode and the negative electrode and impregnated with a nonaqueous electrolyte containing γ-butyrolactone.

2. The nonaqueous electrolyte battery according to claim 1, wherein the negative electrode and the positive electrode are arranged spatially apart from each other.

3. The nonaqueous electrolyte battery according to claim 1, wherein the sum of lithium hydroxide and lithium oxide falls within not less than 0.1% to not more than 0.3% by weight based on the amount of the positive electrode active material.

4. The nonaqueous electrolyte battery according to claim 1, wherein the amount of γ-butyrolactone contained in the nonaqueous electrolyte falls within not less than 10% to not more than 90% by volume of the nonaqueous electrolyte.

5. The nonaqueous electrolyte battery according to claim 1, wherein the surface of the positive electrode is covered with a film containing a ring-opened polymer of γ-butyrolactone.

6. The nonaqueous electrolyte battery according to claim 1, wherein the nonaqueous electrolyte contains at least one of ethylene carbonate and propylene carbonate.

7. The nonaqueous electrolyte battery according to claim 1, wherein the nonaqueous electrolyte contains at least one of ethylene carbonate in an amount of not less than 5% to not more than 60% by volume of the nonaqueous electrolyte and propylene carbonate in an amount of not less than 5% to not more than 60% by volume of the nonaqueous electrolyte.

8. The nonaqueous electrolyte battery according to claim 1, wherein the lithium-nickel composite oxide is represented by formula (1) given below:
LiNi₁₋ₓMₓO² (1)
where the element M is at least one element selected from the group consisting of Co, Al, Mn, Cr, Fe, Nb, Mg, B and F, and the molar ratio x satisfies 0≦x<1.

9. The nonaqueous electrolyte battery according to claim 1, wherein the lithium-nickel composite oxide is represented by formula (1) given below:
LiNi₁₋ₓMₓO² (1)
where the element M is at least one element selected from the group consisting of Co, Al and Mn, and the molar ratio x satisfies 0≦x≦0.5.

10. A battery pack comprising a plurality of nonaqueous electrolyte batteries, wherein the nonaqueous electrolyte battery comprises:
a case;
a positive electrode housed in the case and including a positive electrode active material containing a lithium-nickel composite oxide and at least one of lithium hydroxide and lithium oxide, the sum of lithium hydroxide and lithium oxide falling within not less than 0.1% to not more than 0.5% by weight based on the total amount of the positive electrode active material;
a negative electrode housed in the case and capable of lithium intercalation-deintercalation; and
a separator sandwiched between the positive electrode and the negative electrode and impregnated with a nonaqueous electrolyte containing γ-butyrolactone.

11. The battery pack according to claim 10, wherein the positive electrode and the negative electrode are arranged spatially apart from each other.

12. The battery pack according to claim 10, wherein the sum of lithium hydroxide and lithium oxide falls within not less than 0.1% to not more than 0.3% by weight based on the amount of the positive electrode active material.

13. The battery pack according to claim 10, wherein the amount of γ-butyrolactone contained in the nonaqueous electrolyte falls within not less than 10% to not more than 90% by volume of the nonaqueous electrolyte.

14. The battery pack according to claim 10, wherein the surface of the positive electrode is covered with a film containing a ring-opened polymer of γ-butyrolactone.

15. The battery pack according to claim 10, wherein the nonaqueous electrolyte contains at least one of ethylene carbonate and propylene carbonate.

16. The battery pack according to claim 10, wherein the nonaqueous electrolyte contains at least one of ethylene carbonate in an amount of not less than 5% to not more than 60% by volume of the nonaqueous electrolyte and propylene carbonate in an amount of not less than 5% to not more than 60% by volume of the nonaqueous electrolyte.

17. The battery pack according to claim 10, wherein the lithium-nickel composite oxide is represented by formula (1) given below:
LiNi₁₋ₓMₓO² (1)
where the element M is at least one element selected from the group consisting of Co, Al, Mn, Cr, Fe, Nb, Mg, B and F, and the molar ratio x satisfies 0≦x<1.

18. The battery pack according to claim 10, wherein the lithium-nickel composite oxide is represented by formula (1) given below:
LiNi₁₋ₓMₓO² (1)
where the element M is at least one element selected from the group consisting of Co, Al and Mn, and the molar ratio x satisfies 0≦x≦0.5.

19. A positive electrode active material, comprising a lithium-nickel composite oxide and at least one of lithium hydroxide and lithium oxide, wherein:
the sum of lithium hydroxide and lithium oxide falls within not less than 0.1% to not more than 0.5% by weight based on the total amount of the positive electrode active material;
the positive electrode active material has a core region and an outer region; and
the sum of lithium hydroxide and lithium oxide in the core region falls within not less than 50% to not more than 200% of the sum of lithium hydroxide and lithium oxide in the outer region.

20. The positive electrode active material according to claim 19, wherein the positive electrode active material is formed of a porous particle, in which the boundary between the outer region and the core region from the upper surface of the porous particle is on 0.25 times as much as the diameter (μm) of the porous particle, and the boundary is defined as the core region.
